(19) United States
(12) Patent Application Publication
(10) Pub. No.: US 2007/0079483 A1
(43) Pub. Date: Apr. 12, 2007

(54) Clamped structure and methods for use in trawl mesh and the like

(76) Inventor: Guõmundur Gunnarsson, Hafnafjorour (IS)

Correspondence Address: DONALD E. SCHREIBER, POST OFFICE BOX 2926, KINGS BEACH, CA, 96143-2926, US

(21) Appl. No.: 10/578,161

(22) PCT Filed: Dec. 2, 2004
(86) PCT No.: PCT/US04/40780

§ 371 Date: May 4, 2006

Related U.S. Application Data
(60) Provisional application No. 60/527,345, filed on Dec. 5, 2003.

(51) Int. Cl. F16G 11/00

(52) U.S. Cl. 24/129 R

(57) ABSTRACT

A clamped connection (10) couples together at least first and second sections (12, 14) of at least one line (11) which mesh mechanically. The clamped connection (10) includes a ferrule (16) which receives the sections (12, 14), and a gripping pad (22) situated between them. Swaging the ferrule (16) meshes the sections (12, 14) through the gripping pad (22) so compressive forces applied to the sections (12, 14) required to prevent their slippage relative to one another are reduced, and breaking strength retention of the line (11) is improved. A method for forming the clamped connection includes the steps of: (i) situating within the ferrule (16) the two sections (12, 14); (ii) situating the gripping pad (22) within the ferrule (16) between the sections (12, 14); and (iii) swaging the ferrule (16).

### TECHNICAL FIELD

The present invention relates to clamping apparatuses and methods for coupling together two (2) or more sections of line (s), and especially to clamping apparatuses methods useful in the manufacture of pelagic trawl mesh.

### BACKGROUND ART

Clamping sections of synthetic and natural (e.g. wire) ropes to join them together is well known in the art. It is also well known clamped connections utilizing known clamps and methods are significantly weaker than that achievable by an optimum knot or hand splice connections. However, optimal knotting or splicing of the ropes or other lines is not always a practical option. Furthermore, many types of widely employed ropes cannot be spliced which increases trawl mesh manufacturing cost in relation to maximal use of the strength properties of widely employed cordage. Thus, the only available reliable connection methods under a great variety of circumstances for many types of cordage are either known clamping technologies, or knots.

Problematically, known clamping technologies and known knotting technologies both fail to conserve the strength properties of the cordage as compared to spliceable counter-parts of similar material (e.g. fiber) makeup. For example, many modern ropes and are so stiff that knotting them weakens them significantly, i.e. very hard and stiff ropes are damaged by knotting. Similarly, clamping synthetic cordage with a comparatively hard ferrule damages and weakens the rope's synthetic fibers.

Nonetheless, despite the drawbacks exhibited by clamped and knotted synthetic cordage, and the advantages to spliced synthetic cordage, much cordage that cannot be spliced continues to be widely employed in manufacturing trawl mesh due to other highly favorable properties of such non-spliceable cordage. Favorable properties of non-spliceable cordage may include abrasion resistance, durability, and stiffness which are advantageous for pelagic trawl mesh. Thus, there exists a long felt need in the industry for a clamp apparatus and clamping method for coupling together two (2) or more sections of line(s) that is both economical and produces essentially splice-like strength retention both from clamped cordage and other lines, as well as from cordage that cannot be spliced.

Published Patent Cooperation Treaty (“PCT”) international patent applications PCT/US96/16419, PCT/US98/07848 and PCT/US99/02820, respectively, publication numbers WO 97/13407, WO 98/46070 and WO 99/39572, disclose various different types of trawl mesh and methods for its manufacture which are herein incorporated by reference. Reference to the texts of these international patent applications assist in understanding the present invention. Any terms used herein are intended to have the same meaning as that in these published international applications, except and unless in the event of a contradiction of terms, in which case the use and definition of terms appearing herein is applicable to this patent application.

The PCT patent applications identified above disclose clamping of trawl mesh bars so as to form looped ends and other mesh connections which are relevant to the present invention.

### DISCLOSURE OF INVENTION

An object of the present invention is to provide an improved clamp apparatus and clamping method which retains more of the straight line break strength of the coupled sections of rope or other line.

Another object of the present invention is to provide a clamp apparatus and a clamping method which permits retaining straight line strength of clamped synthetic and other ropes which is close to or greater than that achieved both by hand spliced ropes, or by other connection of ropes which cannot be spliced.

Another object of the present invention is to provide a clamp apparatus and clamping method wherein the final clamp coupled connection retains between eighty percent (80%) and one hundred percent (100%) of the straight line break strength of the coupled sections of rope or other line.

Another object of the present invention is to simplify the manufacture of trawl mesh.

Another object of the present invention is to reduce the time required for manufacturing trawl mesh.

Another object of the present invention is to provide more reliable trawl mesh.

Another object of the present invention is to provide trawl mesh that is more uniform.

Briefly, a clamped connection in accordance with the present invention couples together at least first and second sections of at least one line which are shaped so as to be capable of meshing mechanically. The clamped connection includes a ferrule for receiving the at least two sections, and a gripping pad situated between the at least two sections. Swaging the ferrule meshes the at least two sections through the gripping pad so that compressive forces applied to the at least two sections required to prevent slippage of the at least two sections relative to one another are reduced, and breaking strength retention of the line is improved.

The present invention also includes an improved method for forming a clamped connection for coupling together at least first and second sections of at least one line which are shaped so as to be capable of meshing mechanically. The improved method includes the steps of:
(i) situating within a ferrule at least two mechanically meshing sections of at least one line;
(ii) situating a gripping pad within the ferrule between the at least two sections; and
(iii) swaging the ferrule so that the at least two sections deform the gripping pad and mesh through the gripping pad.
   In this way compressive forces applied to the at least two sections required to prevent slippage of the at least two sections relative to one another are reduced, and breaking strength retention of the line is improved.

An advantage of the present invention is that ropes which cannot be spliced can be connected with a strength retention comparable to that of like ropes that can be spliced. Thus, the present invention dramatically improves strength retention for an entire class of cordage distinguished by ropes that cannot be spliced.

### DEFINITIONS

The following definitions are not necessarily understood by those normally skilled in the art, and are thus taught herein for clarity of the present disclosure:

HELIX ROPE means that rope or other line shown in FIG. 29 of published international application PCT/US98/07848 (WO 98/46070) and in FIG. 6 of published international application PCT/US99/02820 (WO 99/39572), and is sold as a component of pelagic trawls under the trade name “Helix” by Hampidjan, H F, of Iceland.

NOMINAL DIAMETER OF A ROPE means the diameter of a circle having an area which is equal to the cross-sectional area of a rope that has a non-circular cross-section.

NON-SPLICEABLE ROPE means a synthetic or natural rope or other line that fails to conserve at least 80% (eighty percent) of its maximal straight line break strength when spliced. Examples of Non-Spliceable Rope are certain types of sheath-enclosed ropes that, when a splice is made by tucking the core back into itself, insufficient strength is retained from the sheath, and thus the splice greatly reduces the rope's strength.

These and other features, objects and advantages will be understood or apparent to those of ordinary skill in the art from the following detailed description of the preferred embodiment as illustrated in the various drawing figures.

### BRIEF DESCRIPTION OF DRAWINGS

FIG. 1 is a is a plan view illustrating a clamped connection in accordance with the present invention in which an eye is formed by looping a line back onto itself and then swaging a ferrule about the doubled sections of the line.

FIG. 2 is a partially sectioned view of the interior of the clamped connection of FIG. 1.

FIG. 3 is an expanded view of the clamped connection shown in FIG. 2 before swaging the ferrule about the doubled sections of the line.

### BEST MODE FOR CARRYING OUT THE INVENTION

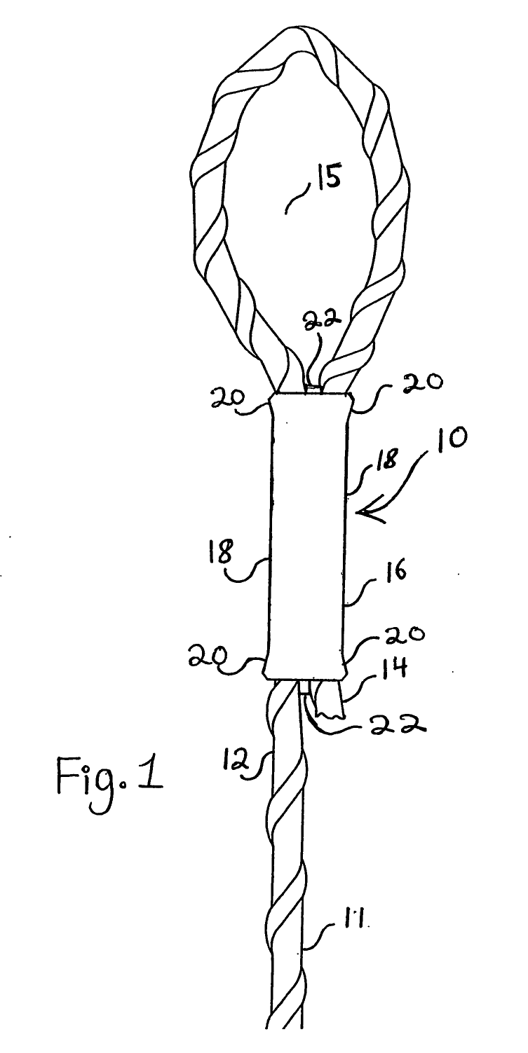

As illustrated in FIG. 1, a clamped connection 10 in accordance with the present invention for the particular application disclosed herein may be used for permanently coupling at least two sections of a line 11. In the illustration of FIG. 1, the clamped connection 10 couples together a first section 12 of the line 11 that is the standing section, and a second section 14 that is the tag section. While in the illustration of in FIG. 1 the clamped connection 10 of the present invention is shown clamping together two sections of a single line 11 to establish a looped eye 15, a clamped connection 10 in accordance with the present invention may also be used for coupling together sections of two individual lines, and no looped eye need necessarily be formed.

The clamped connection 10 includes a non-uniformly swaged ferrule 16, preferably made from aluminum, which has a swaged portion 18 and non-swaged ends 20. The ferrule 16, which may be purchased from Blue Line company of Denmark, has a length as disclosed herein, and a cross section as standard for receiving side by side two (2) or more sections of lines (including ropes). Such a cross section is common for ferrules generally available from Blue Line, and may be described as “rectangular with rounded short sides. Also shown is a gripping pad 22, that may be a piece of leather, or two or more strips of:leather side by side.

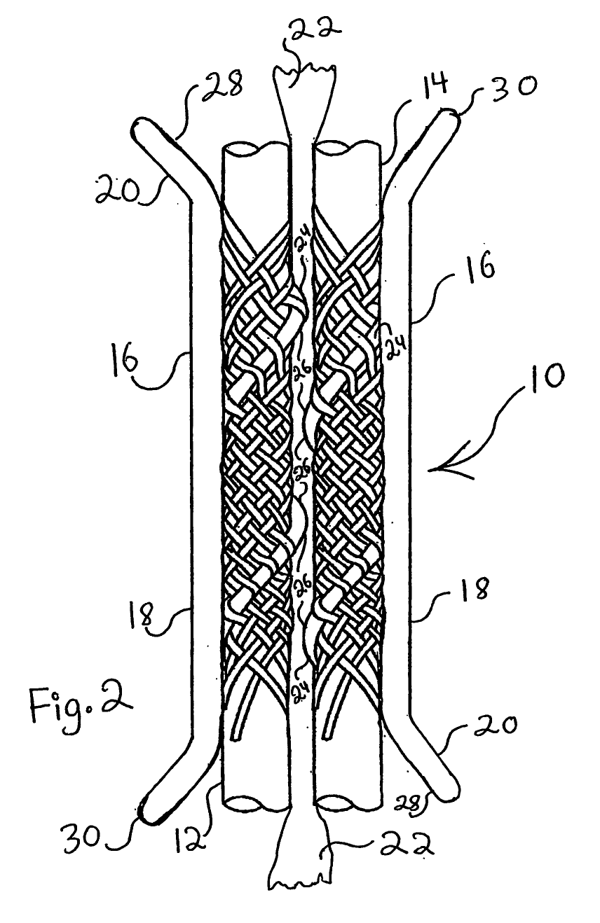

FIG. 2 is a more detailed view of the interior of the clamped connection 10 of FIG. 1. In order to permit viewing of the arrangement of the various components of the clamped connection 10 of the present invention, the non-uniformly swaged ferrule 16 is shown in a cross section taken parallel to its long dimension, as is the gripping pad 22, while the first and second sections 12, 14 of the line 11 are shown in plan view.

As shown in FIG. 2, the first and second sections 12, 14 are part of a Helix Rope having a screw-gear like configuration defined by helixing twines 24 making up screw gears 26 which mesh mechanically. The first and second sections 12, 14 are arranged side by side within the ferrule 16 in such a way that their screw gears 26 mesh, even if imperfectly, meaning that there can be significant free space between mating and/or opposing surfaces of the screw gears 26. To fill free space between the helixing twines 24, the gripping pad 22 is positioned between the first and second sections 12, 14.

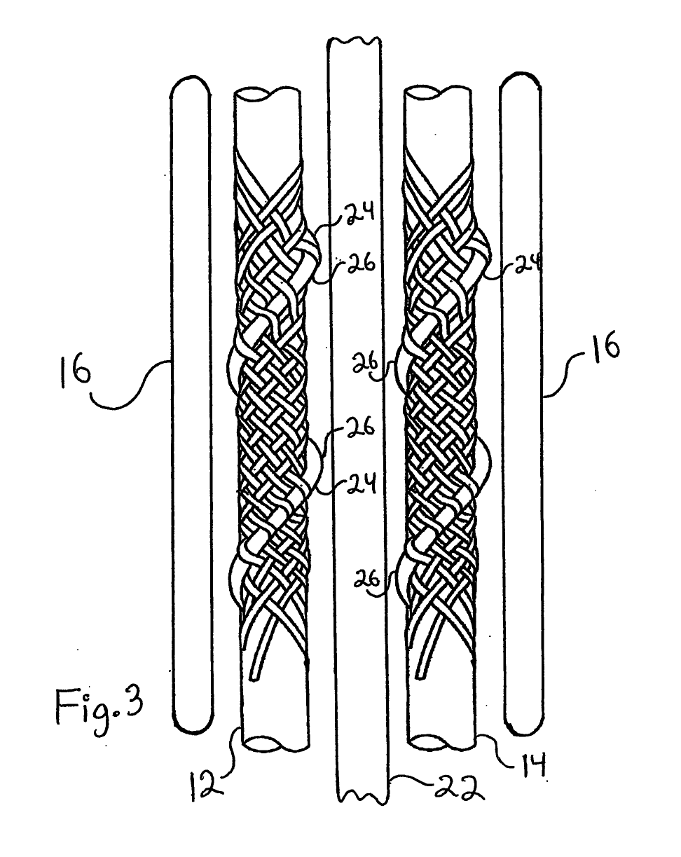

FIG. 3 provides an expanded view prior to the swaging of the ferrule 16 and showing the components of FIG. 2 immediately prior to the swaging of the ferrule 16. Swaging the ferrule 16 in the manner and fashion of the present invention forms, the clamped connection 10.

In reference again to FIG. 2, upon swaging of the ferrule 16 the compressive forces generated by the now deformed ferrule 16 drive protruding screw gears 26 into the gripping pad 22 which thereafter occupies free space between the helixing twines 24 on the first and second sections 12, 14, respectively. Consequently, in order for the first and second sections 12, 14 to slide past and/or along one another, as occurs if the clamped connection were to fail, their respective screw gears must either break one another off while as well rupturing the gripping pad 22, or must expand the swaged ferrule 16. Either of the two preceding possibilities requires so much energy and increases so much the frictional and other mechanical contact of the first and second sections 12, 14 with the interior surfaces of the swaged ferrule 16, that it cannot occur without first breaking one or both of the first and second sections 12, 14. Thus, the clamped connection 10 of the present invention provides far greater resistance to slippage.

Advantageously, because the clamped connection 10 dramatically improves resistance to slippage, significantly less pressure is needed to retain the first and second sections 12, 14 in their relative positions side by side within the clamped connection 10. Consequently, relatively little pressure is used when swaging the ferrule 16 as compared to industry standard practice for any two lines of a similar nominal diameter as the first and second sections 12, 14. A result of the lower swaging pressure is that less, including no, damage is incurred by synthetic first and second sections 12, 14. Reduced or no damage and retained structural integrity permits the first and second sections 12, 14 to retain most or all of their strength.

To form flared ends 28 on the ferrule 16, a swage that is shorter than the entire length of the ferrule 16 is used. Thus, only the swaged portion 18 of the ferrule 16 is fully swaged which causes the swaged portion 18 to both constrict and elongate thus lengthening the swaged ferrule 16 to its required extent. Due to swaging of the swaged portion 18, the non-swaged ends 20 of the ferrule 16 flare outward thereby providing a soft, non-cutting terminus to the swaged ferrule 16 which prevents damaging the first and second sections 12, 14 during field operations. Furthermore, end edges 30 of the ferrule 16 are rounded off, preferably by a robot, thus further precluding damage to synthetic first and second sections 12, 14 during field operations.

### INDUSTRIAL APPLICABILITY

In modern trawl net lofts, large size {e.g. larger than four meter (4 m) } pelagic trawl mesh is manufactured almost exclusively by hand. Such larger trawl mesh is manufactured by hand because an excessive amount of material is wasted in shaping large mesh size sheet netting to a trawl's design parameters. In such hand manufacture, due to the relatively large diameter of the lines (e.g. ropes) employed, and due to the fact that, for strength retention, cutting the lines is undesirable unless absolutely necessary, manufacturing knotted larger pelagic trawl mesh using rope that cannot be spliced requires pulling relatively long lengths, e.g 100 m lengths, of relatively heavy lines through knot after knot. Consequently, manufacturing knotted larger pelagic trawl mesh from such rope is very time consuming and labor intensive.

Conversely, forming clamped mesh connections in accordance with the present invention permits precutting much shorter individual mesh legs on a workbench, and then swaging them together on a jig. Alternatively, the mesh legs may be precut and clamped connections 10, illustrated in FIG. 1, formed in accordance with the present invention. The clamped connections 10 may then be pulled through one another on a jig. Either of the two (2) preceding clamping methods for manufacturing larger pelagic trawl mesh using rope that cannot be spliced dramatically reduces the manufacturing time and labor. Furthermore, either of the two (2) preceding methods also reduces the physical strength required for those manufacturing larger pelagic trawl mesh from such rope. Lastly, since the clamped connection of the present invention retains more straight line breaking strength in comparison with other ways for forming connections, lighter and less costly ropes may be used in manufacturing pelagic mesh which has strength comparable to that manufactured in other ways.

Clamping Method:

The improved method includes swaging (including “pressing”) a ferrule 16 about the first and second sections 12, 14 of Helix Rope or other types of rope exhibiting screw gears 26 and which the clamp is intended to couple. The method includes:
(i) situating the gripping pad 22, such as a piece of leather such as cow hide leather, between the first and second sections 12, 14 which are to be coupled so that the gripping pad 22 is:
   a. generally parallel both with the two first and second sections 12, 14 and with the long dimension of the ferrule 16;
   b. generally rectangular in outline;
   c. having a width at least equal to the largest width and/or diameter of the largest of the first and second sections 12, 14 to be coupled;
   d. having a length at least equal to the final length of the ferrule 16 (the after swaging/pressing length), and preferably extending approximately one (1) centimeter beyond both edges 30 of the ferrule 16; and
   e. having a thickness sufficient so that, after forming the clamped connection 10, the resultant break strength is significantly greater than 50% (fifty percent) of the straight line break strength of the line, and preferably at least 80% (eighty percent) of straight line break strength;
(ii) using a swage (including “press”) that is undersized by current industry standards for the particular ferrule 16, preferably one (a single) number down in size;
(iii) using a swage that is shorter than the ferrule 16;
(iv) lubricating with a suitable lubricant, such as a suitable petroleum based lubricant, the interior surface of the swage (press) where the surface of the swage (press) contacts the exterior surface of the ferrule 16;
(v) swaging (pressing) the ferrule 16 in such a way that the pressure compresses the gripping pad 22 between the first and second sections 12, 14; and
(vi) removing (including reducing) “flash” formed by material of the ferrule 16 which squeezes between opposing parts of the swage during swaging, i.e. (v) above.
   Removing “flash” formed on the ferrule 16 during swaging is important because it is sharp, and therefore can easily cut and weaken ropes used for making pelagic trawl mesh.

The preceding method reduces deformation of the first and second sections 12, 14 within the ferrule 16, while concurrently increasing the uniformity of the frictional contact between the first and second sections 12, 14 themselves as well as between the first and second sections 12, 14 and the ferrule 16. Thus, the preceding method minimizes damaging forces applied to the first and second sections 12, 14 while maximizing grabbing and restraining forces applied to portions of the first and second sections 12, 14 within the ferrule 16. The preceding method also allows a greater “flow” of aluminum during the swaging process, resulting in a longer final shape and/or length for the swaged ferrule 16, and a more uniform deformation of the ferrule 16 about the first and second sections 12, 14 as well as a more uniform application of compressive forces about the first and second sections 12, 14. Connecting the first and second sections 12, 14 in this way reduces compressive forces applied to the first and second sections 12, 14 required to prevent slippage of the first and second sections 12, 14 relative to one another, and improve retention of straight line breaking strength of the line 11.

Breaking strength resulting from the clamping method and apparatus of the present invention have exceeded eighty percent (80%) and even matched ninety seven percent (97%) of the straight line break strength of the line 11, especially Helix Rope. Such strength retention is a result never previously achieved with any known synthetic rope by any previously known clamping method.

If desired, experimentation permits determining precisely:
(i) what dimension of a swage (press) is best suited for:
   a. any particular nominal diameter of Helix Rope; and
   b. any particular ferrule 16 used for forming the clamped connection 10 of the present invention for the coupling of any particular screw geared ropes; and
(ii) precisely what dimension is useful for a leather, or non-leather material, gripping pad 22 which may also be experimentally determined useful for practicing the method of the present invention.
   A gripping pad 22 made from a leather treated with preservative chemicals so as to resist deterioration in a salt water and varying temperature environment, including cold and hot, is preferred.

Helix Rope Clamping Methods:

In reference to Helix Rope as defined herein, the clamping method of the present invention preferably includes the following:
(i) aligning the helixing twines 24 on each of the first and second sections 12, 14 so that the sides of the helixing twines 24 inside the ferrule 16 on either side of the gripping pad 22 mesh like the teeth of gears, i.e the two screw gears 26 respectively on each of the first and second sections 12, 14 do not confront one another; and
(ii) the ferrule 16 used in forming the clamped connection 10 of the present invention is preferably sufficiently long so as to enclose at least one complete (360°) rotation of the helixing twines 24 about a longitudinal axis of each of the first and second sections 12, 14 of Helix Rope.
   Two (2) or more complete rotations of the helixing twine, i.e. at least two abutting faces of screw gears 26, may also be enclosed within the ferrule 16. Configuring the clamped connection 10 in this way dramatically reduces slippage tendencies with less constrictive forces needed. Thus, less damaging forces are applied and greater Helix Rope strength is maintained. Accordingly, the clamping method of the present invention preferably includes not only aligning the helixing twines 24 of the first and second sections 12, 14 of Helix Rope that are within the ferrule 16 so the sides of the helixing twines 24 on each side mesh (much like teeth mesh in gears), but also includes enclosing in the ferrule 16 at least one complete rotation of the helixing twines 24, and certainly not less than one half (½) complete rotation of the helixing twines 24.

Although the present invention has been described in terms of the presently preferred embodiment, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the following claims be interpreted as encompassing all alterations, modifications, or alternative applications as fall within the true spirit and scope of the invention.

1. A clamped connection (10) for coupling together at least first and second sections (12, 14) of at least one line (11), the at least two sections (12, 14) being shaped so as to be capable of meshing mechanically, the clamped connection (10) comprising:
a ferrule (16) for receiving the at least two sections (12, 14); and
a gripping pad (22) situated within the ferrule (16) between the at least two sections (12, 14);
whereby swaging the ferrule (16) meshes the at least two sections (12, 14) through the gripping pad (22) so that compressive forces applied to the at least two sections (12, 14) required to prevent slippage of the at least two sections (12, 14) relative to one another are reduced, and breaking strength retention of the line (11) is improved.

2. The clamped connection (10) of claim 1 wherein the at least two sections (12, 14) are shaped so as to mesh imperfectly.

3. The clamped connection (10) of claim 1 wherein the at least two sections (12, 14) are formed with screw gears (26).

4. The clamped connection (10) of claim 1 wherein the at least two sections (12, 14) are part of at least one Helix Rope.

5. The clamped connection (10) of claim 1 wherein the gripping pad (22) is formed by at least two strips of material.

6. The clamped connection (10) of claim 1 wherein the gripping pad (22) is formed from leather.

7. The clamped connection (10) of claim 1 wherein the swaged ferrule (16) has a rounded off end edge (30).

8. The clamped connection (10) of claim 1 wherein the ferrule (16) is not uniformly swaged.

9. The clamped connection (10) of claim 8 wherein the swaged ferrule (16) has a swaged portion (18) and a non-swaged end 20.

10. The clamped connection (10) of claim 8 wherein the swaged ferrule (16) includes a flared end (28).

11. The clamped connection (10) of claim 3 wherein the swaged ferrule (16) is sufficiently long so as to enclose at least two abutting faces of the screw gears (26) of the at least two sections (12, 14).

12. The clamped connection (10) of claim 8 wherein:
(i) the at least two sections (12, 14) are formed with screw gears (26); and
(ii) the swaged ferrule (16) is sufficiently long so as to enclose at least two abutting faces of the screw gears (26) of the at least two sections (12, 14).

13. The clamped connection (10) of claim 4 wherein the swaged ferrule (16) is sufficiently long so as to enclose at least one complete (360°) rotation of at least one helixing twine (24) about a longitudinal axis of at least one of the sections (12, 14) of Helix Rope.

14. The clamped connection (10) of claim 13 wherein the clamped connection (10) is used for forming pelagic trawl mesh.

15. An improved method for forming a clamped connection (10) for coupling together at least first and second sections (12, 14) of at least one line (11), the at least two sections (12, 14) being shaped so as to be capable of meshing mechanically, the improved method comprising the steps of:
(i) situating within a ferrule (16) at least two mechanically meshing sections (12, 14) of at least one line (11);
(ii) situating a gripping pad (22) within the ferrule (16) between the at least two sections (12, 14); and
(iii) swaging the ferrule (16) so that the at least two sections (12, 14) deform the gripping pad (22) and mesh through the gripping pad (22);
whereby compressive forces applied to the at least two sections (12, 14) required to prevent slippage of the at least two sections (12, 14) relative to one another are reduced, and breaking strength retention of the line (11) is improved.

16. The improved method of claim 15 further comprising the step of situating a second gripping pad (22) within the ferrule (16) between the at least two sections (12, 14).

17. The improved method of claim 15 further comprising the step of forming the gripping pad (22) from leather.

18. The improved method of claim 15 further comprising the step of rounding off an end edge (30) of the ferrule (16).

19. The improved method of claim 15 wherein the ferrule (16) is swaged non-uniformly.

20. The improved method of claim 15 wherein the ferrule (16) is swaged to have a swaged portion (18) and a non-swaged end 20.

21. The improved method of claim 15 wherein the ferrule (16) is swaged to have a flared end (28).

22. The improved method of claim 15 further comprising the step of forming pelagic trawl mesh employing the clamped connection (10).
